(19) United States
(12) Patent Application Publication
(10) Pub. No.: US 2020/0256372 A1
(43) Pub. Date: Aug. 13, 2020

(54) Concrete Screw

(71) Applicant: Kuo-Tai Hsu, Tainan (TW)

(72) Inventor: Kuo-Tai Hsu, Tainan (TW)

(21) Appl. No.: 16/271,958

(22) Filed: Feb. 11, 2019

(51) Int. Cl. F16B 25/00

(52) U.S. Cl. CPC F16B 25/0026; F16B 25/0052

(57) ABSTRACT

A concrete screw is adapted to be driven into a hole in a concrete structure and includes a head, a shank extending from the head, and a thread formed on the shank. The shank includes a front segment and a rear segment adjacent to the head. The thread includes a plurality of thread convolutions. A plurality of oblique ribs are distributed at least on the outer periphery of the front segment of the shank and spaced from one another along the shank circumferentially. Each oblique rib is located between two adjacent thread convolutions at the front segment of the shank. The plurality of oblique ribs can crush and disperse concrete debris which comes out of a hole wall of the hole cut by the thread and keep the shank moved inside the hole straight when the concrete screw is driven into the hole.

### BACKGROUND OF THE INVENTION

### 1. Field of the Invention

The present invention relates to a screw and, more particularly, to a concrete screw adapted to be driven into a concrete or masonry structure.

### 2. Description of the Related Art

FIG. 1 illustrates a traditional concrete screw 10 including a shank 12, a head 14 formed at an end of the shank 12, and a thread 15 formed on the shank 12. The screw 10 is adapted to be fastened into a concrete structure 16 at the masonry (e.g., brick masonry) and/or concrete to join another structure component 18 on the concrete structure 16. Before driving the screw 10, a worker uses an electric drill (not shown in FIG. 1) to drill a hole 19 in the concrete structure 16. The hole 19 has an hole diameter slightly greater than the shank diameter of the shank 12 but less than the major diameter of the thread 15. Then, with the front end of the shank 12 inserted into the hole 19, the head 14 is driven to rotate by a tool (not shown) such that the hole wall of the hole 19 is cut by the thread 15, and hence the shank 12 can be screwed into the hole 19 until the head 14 gets close to or abuts the structure component 18. However, during the process of the shank 12 driven into the hole 19, plenty of concrete debris coming out of stiffened cement mortars (which are not compressed in contrast to rigid wooden fibers) in the concrete structure 16 cut by the thread 15 worsens the cutting force of the thread 15, retards movement of the shank 12 inside the hole 19, decelerates the screw 10 and even breaks the shank 12. Moreover, the shank 12 driven into the hole 19 in the beginning may be shaken or even deviated.

FIGS. 2 and 3 illustrates another traditional concrete screw 20 including a shank 22, a head 24 formed at an end of the shank 22, and first and second threads 25 and 26 formed on the shank 22. The screw 20 is adapted to be fastened into a concrete structure 16 on which another structure component 28 is fixed. The second thread 26 features its major diameter less than the major diameter of the first thread 25 and almost equal to the hole diameter of the hole 19. When the shank 22 is driven into the hole 19, the second thread 26, which bears against the inner surface of the hole 19 and supports cutting, accelerates the screw 20 moving inside the hole 19. However, concrete debris neither crushed nor dispersed fast by the second thread 26 imposes immense frictional resistances on the shank 22 at the time when sunk in the hole 19 deeply. Accordingly, the shank 22 fails in complete fastening, so that a greater screwing torque must be applied to overcome the resistances and hence probably break the shank 22 off. Moreover, the screw-in process of the shank 22 driven into the concrete structure 16 in the beginning cannot be stabilized by the added second thread 26. Because there is only one contact point between the hole wall and the second thread 26 on any cross section of the shank 22, the shank 22 newly driven into the concrete structure 16 is still shaken such that the screw 20 tends to deviate from the drive direction. In addition, since the second thread 26 has auxiliary function to aid cutting but the debris cut off from the first thread 25 can not be dispersed efficiently by the settlement of the second thread 26 and will keep accumulating between the threads and the hole wall, the hole wall inside the hole 19 on retrieval of the screw 20 is damaged by interactive frictions between the first and second threads 25, 26 and concrete debris directly or indirectly and fails to support pull-out strength through which the screw 20 is driven into the hole 19 again.

### BRIEF SUMMARY OF THE INVENTION

Thus, an objective of the present invention is to provide a concrete screw which is able to efficiently crush concrete debris and evenly disperse concrete debris around a shank of the concrete screw for accelerative movement of the concrete screw which is driven into a concrete structure, kept unshaken in the beginning, not deviated from a drive direction, and fastened stably and robustly.

To achieve this and other objectives, a screw of the present invention is adapted to be driven into a hole with a hole diameter in a concrete structure. The screw includes a head, a shank extending from the head and defining a longitudinal axis, a thread, and a plurality of oblique ribs. The shank includes a front segment and a rear segment spaced from the front segment along the longitudinal axis and located between the front segment and the head. The shank has a shank diameter less than the hole diameter of the hole. The thread is spirally formed on the shank and extends from the front segment toward the head. The thread includes a plurality of thread convolutions and has a major diameter greater than the hole diameter. The plurality of oblique ribs are distributed at least on the outer periphery of the front segment of the shank and located between two adjacent thread convolutions. The plurality of oblique ribs are spaced from one another along the shank circumferentially and define a rib top diameter less than the major diameter of the thread and slightly less than or equal to the hole diameter. The plurality of oblique ribs can quickly crush and disperse concrete debris which comes out of a hole wall of the hole cut by the thread when the concrete screw is driven into the hole.

In a form, at least three separate oblique ribs are designed between two adjacent thread convolutions at the front segment of the shank, and each oblique rib spirally extends along the longitudinal axis.

In a preferred form, three oblique ribs are designed between two adjacent thread convolutions at the front segment of the shank and spaced 120 degrees apart.

In a preferred form, the thread extends from the front segment to the rear segment, and the at least three separate oblique ribs extend from the front segment to the rear segment of the shank.

In a preferred form, a plurality of notches is designed in the thread convolutions at the front segment of the shank for development of a plurality of teeth on the thread at the front segment.

The present invention will become clearer in light of the following detailed description of illustrative embodiments of this invention described in connection with the drawings.

### DESCRIPTION OF THE DRAWINGS

The illustrative embodiment may best be described by reference to the accompanying drawings where:

FIG. 1 is a schematic view for a traditional concrete screw driven into a concrete structure.

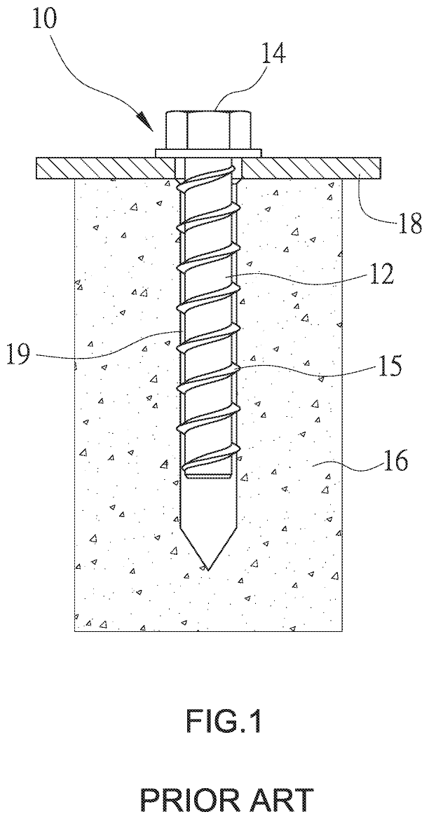

FIG. 2 is a schematic view for another traditional concrete screw driven into a concrete structure.

FIG. 3 is a sectional view taken along line 3-3 of FIG. 2.

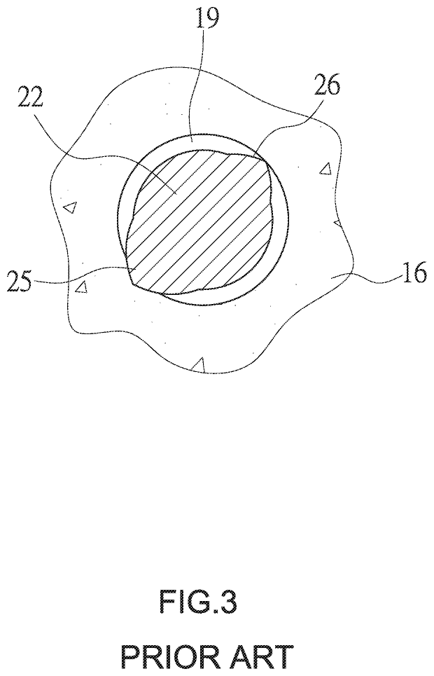

FIG. 4 is a perspective view of a concrete screw according to a first embodiment of the present invention.

FIG. 5 is a sectional view taken along line 5-5 of FIG. 4.

FIG. 6 is a schematic view which illustrates the concrete screw in FIG. 4 driven into a concrete structure in the beginning.

FIG. 7 is a sectional view taken along line 7-7 of FIG. 6.

FIG. 8 is a schematic view which illustrates the concrete screw in FIG. 6 totally fastened into the concrete structure.

FIG. 9 is a plan view of a concrete screw according to a second embodiment of the present invention.

FIG. 10 is a perspective view of a concrete screw according to a third embodiment of the present invention.

FIG. 11 is a sectional view taken along line 11-11 of FIG. 10.

FIG. 12 is a perspective view of a concrete screw according to a fourth embodiment of the present invention.

### DETAILED DESCRIPTION OF THE INVENTION

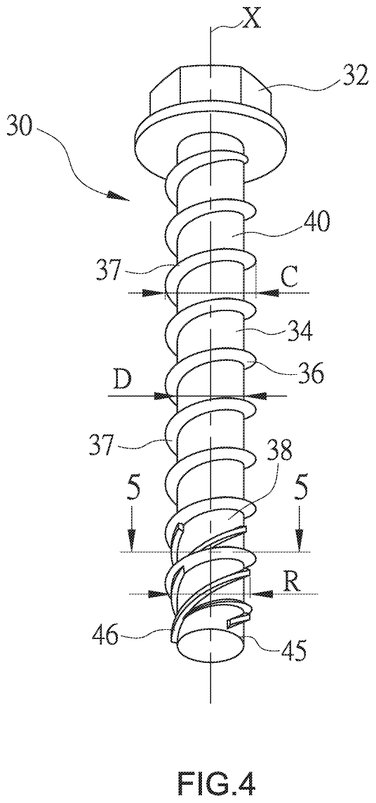

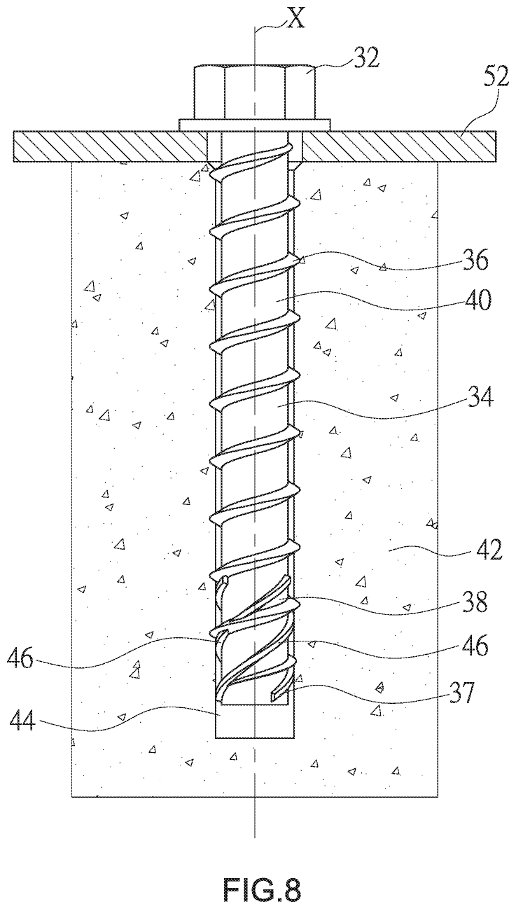

A concrete screw 30 according to a first embodiment of the present invention is shown in FIGS. 4 through 8 of the drawings and generally includes a head 32, a shank 34 extending from the head 32, and a thread 36 formed on the shank 34. The shank 34 defining a longitudinal axis X includes a front segment 38 and a rear segment 40 spaced from the front segment 38 along the longitudinal axis X. The rear segment 40 is located between the front segment 38 and the head 32. The shank 34 has a shank diameter D. The front segment 38 and the rear segment 40 may have an identical shank diameter or distinct shank diameters, respectively. The head 32 is used to provide a torque tool (not shown in figures) in combination to apply rotational torque such that the shank 34 can be screwed inside a concrete structure 42.

In general, a hole 44 should be drilled inside the concrete structure 42 with an electric drill (not shown in figures) first for accommodating the shank 34 of the screw 30. The hole 44 has a hole diameter H which is greater than the shank diameter D of the shank 34. The thread 36 is spirally formed on an outer periphery of the shank 34 and extends from the front segment 38 toward the head 32. In this embodiment, the thread 36 extends to the rear segment 40 from a front end 45 of the front segment 38. The thread 36 includes a plurality of thread convolutions 37 and has a major diameter C that is greater than both the shank diameter D and the hole diameter H.

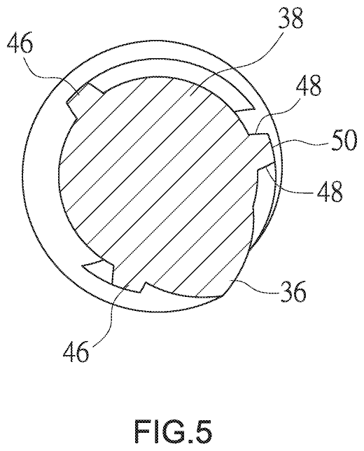

The screw 30 further includes a plurality of oblique ribs 46 formed on the outer periphery of the shank 34 and spaced around the shank 34 circumferentially. Each oblique rib 46 is located between two adjacent thread convolutions 37 of the thread 36 and spirally extends along the longitudinal axis X. In this embodiment, the front segment 38 of the shank 34 is provided with the plurality of oblique ribs 46 with any two oblique ribs 46 parallel to and spaced from each other. Alternatively, the rear segment 40 of the shank 34 is also provided with a plurality of oblique ribs 46. In this embodiment, three oblique ribs 46 are provided between any two adjacent thread convolutions 37 of the thread 36 at the front segment 38 and spaced 120 degrees apart around the shank 34 circumferentially. Accordingly, there are three oblique ribs 46 at any cross section in the front segment 38 of the shank 34, and each oblique rib 46 has a trapezoid cross section with two lateral sides 48 and a planar top face 50 (see FIG. 5). The plurality of oblique ribs 46 have rib tops through which a rib top diameter R is defined. The rib top diameter R is less than the major diameter C and slightly less than or equal to the hole diameter H, that is, not greater than the hole diameter H of the hole 44. Furthermore, an upward extending direction of each oblique rib 46 is similar to an upward direction of the thread 36 extending toward the head 32 (upwardly and slantingly to the upper right). In this embodiment, an inclined angle formed by each oblique rib 46 extending toward the head 32 relative to a horizontal axis perpendicular to the longitudinal axis X is greater than that of the thread 36 extending toward the head 32.

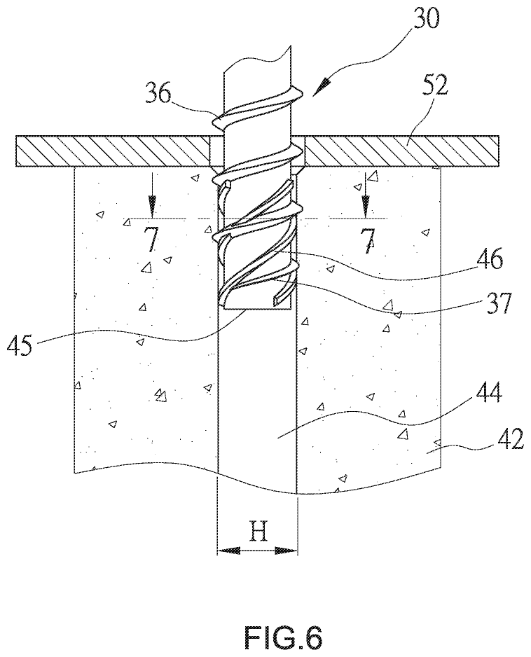

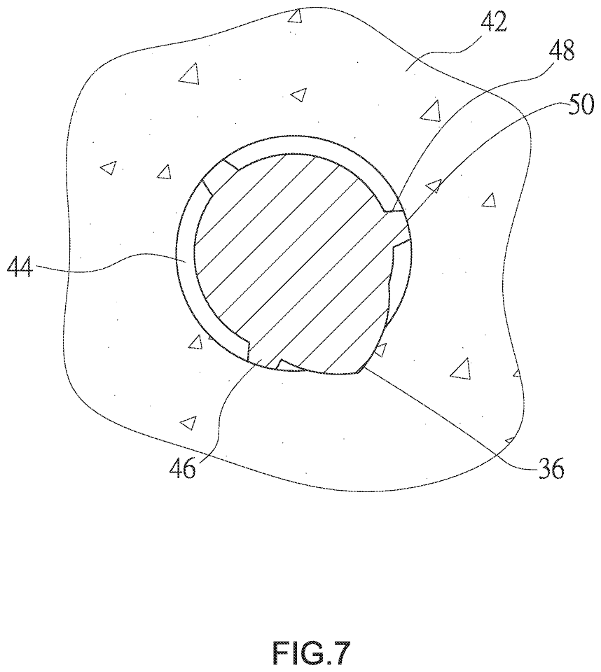

In practice, the front end 45 of the shank 34 is inserted into the hole 44 in the concrete structure 42 as shown in FIG. 6. The major diameter of the thread convolutions 37 at the front end 45 is slightly less than the major diameter C of the thread convolutions 37 at the rear segment 40 for a modest torsion applied on the screw 30 in the beginning. Then, the head 32 is driven to rotate by a torque tool (not shown in figures), and the shank 34 is smoothly screwed into the concrete structure 42 when concrete debris coming out of the hole wall of the hole 44 cut by the thread 36 is crushed by the oblique ribs 46 and dispersed around the shank 34 evenly. The oblique ribs 46 act as the stirrer and grinder that distribute the debris on the shank 34 and even mill the debris into smaller pieces. This will mitigate the friction resistance in the whole screw-in process. Therefore, a structure component 52 can be fixed on the concrete structure 42. Because the separate oblique ribs 46 circumferentially arranged on the shank 34 form the rib top diameter R slightly less than or equal to the hole diameter H of the hole 44, there should be three contact planes formed between the hole wall and the three oblique ribs 46 at any cross section of the front segment 38 of the shank 34 which is being driven into the hole 44 in the beginning (see FIG. 7). Accordingly, the shank 34 driven into the concrete structure 42 is kept unshaken at first and not deviated inside the concrete structure 42 deeply.

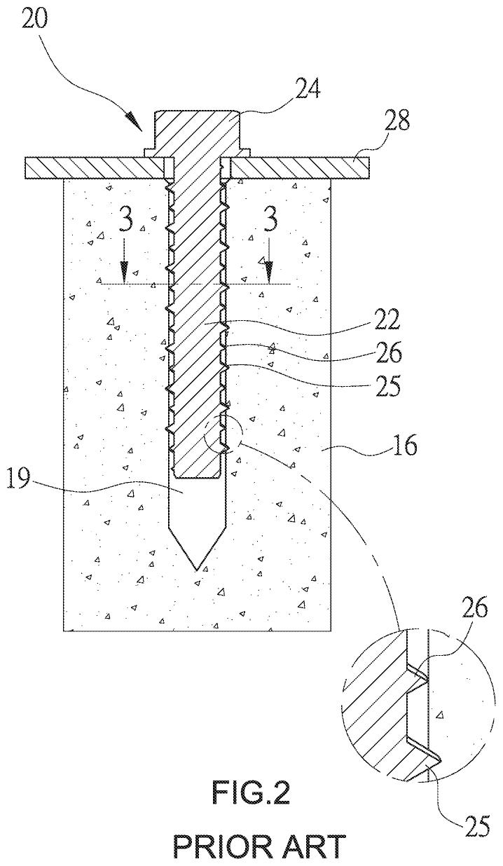

The screw 30 of the present invention offers benefits over the concrete screw 20 in FIG. 2 as follows:

1. Concrete debris is neither crushed nor dispersed by the second thread 26 of the screw 20 quickly. Comparatively, concrete debris is effectively crushed by the oblique ribs 46 and dispersed around the shank 34 being driven into the concrete structure 42 because of the oblique ribs 46 arranged at the front segment 38 and between two adjacent thread convolutions 37. Furthermore, the screw 30 is driven into the hole 44 fast with lesser friction applied on the shank 34 which is being moved inside the hole 44.

2. The lengthwise movement of the screw 20 along the hole wall is not contingent on the second thread 26 of the screw 20. Instead, the lengthwise movement of the screw 30 along the hole wall is effectively corrected by the oblique ribs 46 which keeps the screw 30 driven inside the hole 44 straight and aligned in the beginning and supports the screw 30 to be fastened stably and robustly.

3. The second thread 26 on the screw 20 is used to assist cutting. Thus, the pull-out strength of the screw 20 which was incorrectly fastened and retrieved but is driven into the hole again is weakened because an internal thread carved on the hole wall is damaged by concrete debris. Of the present invention, the oblique ribs 46 perform well in crushing and dispersing concrete debris evenly and correcting a path of the shank 34 moved inside a hole with neither the concrete structure 42 improperly cut nor the hole wall of the hole 44 damaged. Accordingly, even after the screw 30 is withdrawn from the hole 44, the retrieved screw 30 can be repeatedly screwed into the hole 44 to fasten again, maintaining proper pull-out strength.

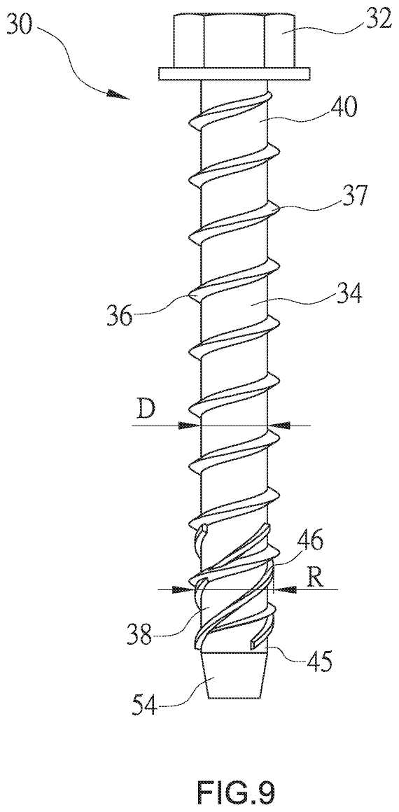

FIG. 9 illustrates the screw 30 in a second embodiment of the present invention. In this embodiment, a taper portion 54 extends from the front end 45 of the front segment 38, so that the front segment 38 of the shank 34 can be aligned with the hole 44 smoothly.

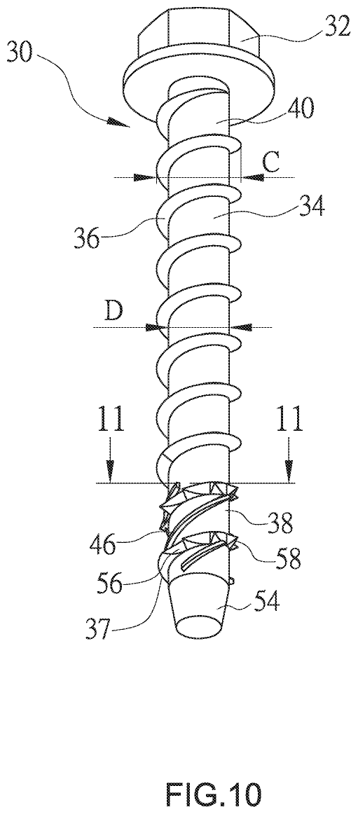

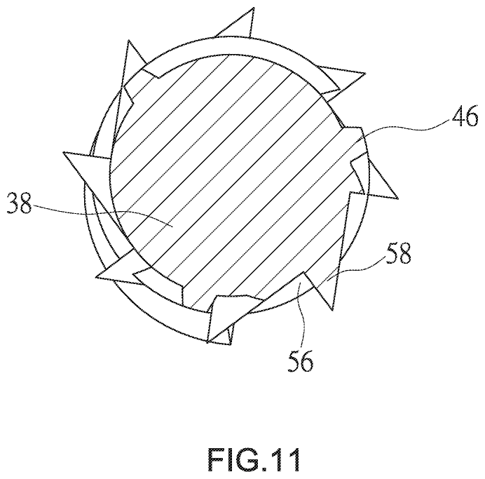

FIGS. 10 and 11 illustrate the screw 30 in a third embodiment of the present invention. In this embodiment, a plurality of notches 56 is designed in the thread convolutions 37 at the front segment 38 for development of a plurality of teeth 58 on the thread 36 at the front segment 38. When the front segment 38 is driven into the hole 44 in the beginning, the teeth 58 support the plurality of oblique ribs 46 to expel concrete debris which is accommodated in the notches 56 for less friction on the shank 34 but higher speed of the screw 30 moved inside the concrete structure 42.

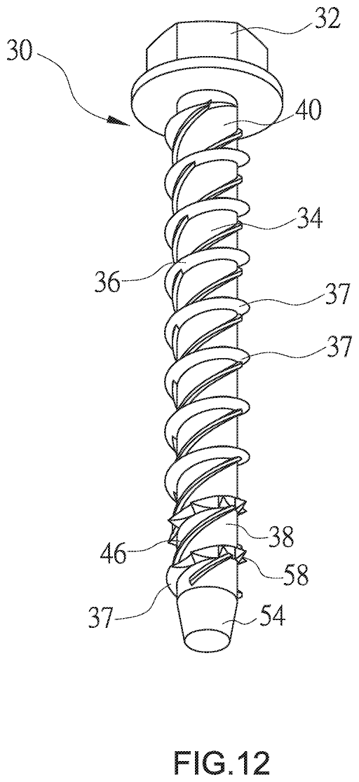

FIG. 12 illustrates the screw 30 in a fourth embodiment of the present invention. In this embodiment, the plurality of oblique ribs 46 provided on the shank 34 extends from the front segment 38 to the rear segment 40, so that at least three separate oblique ribs 46 are designed between any two adjacent thread convolutions 37 at the rear segment 40 of the shank 34 for crushing more concrete debris effectively.

The scope of the invention is to be indicated by the appended claims, rather than by the foregoing description, and all changes which come within the meaning and range of equivalency of the claims are intended to be embraced therein.

1. A screw is adapted to be driven into a hole with a hole diameter in a concrete structure, with the screw comprising:
a head;
a shank extending from the head and defining a longitudinal axis, with the shank including a front segment and a rear segment spaced from the front segment along the longitudinal axis and located between the front segment and the head, with the shank having a shank diameter less than the hole diameter of the hole;
a thread spirally formed on the shank and extending from the front segment toward the head, with the thread including a plurality of thread convolutions and having a major diameter greater than the hole diameter; and
a plurality of oblique ribs distributed at least on an outer periphery of the front segment of the shank and located between two adjacent thread convolutions of the thread, with the plurality of oblique ribs spaced from one another along the shank circumferentially, with the plurality of oblique ribs defining a rib top diameter less than the major diameter of the thread convolutions and slightly less than or equal to the hole diameter, wherein the plurality of oblique ribs can crush and disperse concrete debris which comes out of a hole wall of the hole cut by the thread when the concrete screw is driven into the hole.

2. The screw as claimed in claim 1, wherein at least three separate oblique ribs are designed between two adjacent thread convolutions of the thread at the front segment of the shank, and each oblique rib spirally extends along the longitudinal axis.

3. The screw as claimed in claim 2, wherein three oblique ribs are designed between any two adjacent thread convolutions of the thread at the front segment of the shank and spaced 120 degrees apart.

4. The screw as claimed in claim 1, wherein each oblique rib has a trapezoid cross section with two lateral sides and a planar top face.

5. The screw as claimed in claim 2, wherein the thread extends from the front segment to the rear segment of the shank, and the at least three separate oblique ribs extend from the front segment to the rear segment of the shank.

6. The screw as claimed in claim 1, wherein a plurality of notches is designed in the thread convolutions of the thread at the front segment for development of a plurality of teeth on the thread at the front segment.

7. The screw as claimed in claim 1, wherein an upward extending direction of each oblique rib is similar to an upward direction of the thread extending toward the head.
